(19) United States
(12) Patent Application Publication
(10) Pub. No.: US 2011/0171559 A1
(43) Pub. Date: Jul. 14, 2011

(54) MEMBRANE ELECTRODE ASSEMBLY AND METHOD FOR MAKING THE SAME

(75) Inventors: LI-NA ZHANG, Beijing (CN); KAI-LI JIANG, Beijing (CN); SHOU-SHAN FAN, Beijing (CN)

(73) Assignees: TSINGHUA UNIVERSITY, Beijing (CN); HON HAI PRECISION INDUSTRY CO., LTD., Tu-Cheng (TW)

(21) Appl. No.: 12/200,338

(22) Filed: Aug. 28, 2008

(30) Foreign Application Priority Data
Dec. 19, 2007 (CN) 200710125266.9

(51) Int. Cl. H01M 8/04; H01M 8/10; H01M 8/00; B82Y 30/00

(52) U.S. Cl. 429/481; 429/535; 977/742; 977/948

(57) ABSTRACT

A membrane electrode assembly includes a proton exchange membrane; and a first electrode and a second electrode located on opposite sides of the proton exchange membrane; each electrode comprising a catalyst layer and a gas diffusion layer; the catalyst layer is located between the gas diffusion layer and the proton exchange membrane; and the gas diffusion layer comprising a carbon nanotube film structure, the carbon nanotube film structure comprising at least one carbon nanotube layer, the carbon nanotube layer comprising a plurality of carbon nanotubes oriented along a same direction. A method of making the same is also related.

### BACKGROUND

1. Field of the Invention

The invention generally relates to membrane electrode assemblies and methods for making the same.

2. Discussion of Related Art

Fuel cells can generally be classified into alkaline, solid oxide, and proton exchange membrane fuel cells. The proton exchange membrane fuel cell has received increasingly more attention and has developed rapidly in recent years. Typically, the proton exchange membrane fuel cell includes a number of separated fuel cell work units. Each work unit includes a fuel cell membrane electrode assembly (MEA), flow field plates (FFP), current collector plates (CCP), as well as related support equipment, such as blowers, valves, and pipelines.

The MEA generally includes a proton exchange membrane and two electrodes separately located on two opposite surfaces of the proton exchange membrane. Furthermore, each electrode includes a catalyst layer and a gas diffusion layer. The catalyst layer is configured for being sandwiched between the gas diffusion layer and the proton exchange membrane. The material of the proton exchange membrane is selected from the group consisting of perfluorosulfonic acid, polystyrene sulfonic acid, polystyrene trifluoroacetic acid, phenol formaldehyde resin acid, and hydrocarbons. The catalyst layer includes catalyst materials and carriers. The catalyst materials are selected from the group consisting of metal particles, such as platinum particles, gold particles, and ruthenium particles. The carriers are generally carbon particles, such as graphite, carbon black, carbon fiber or carbon nanotubes. The gas diffusion layer is constituted of treated carbon cloth and carbon paper.

The gas diffusion layer of MEA is mainly formed by a carbon fiber paper. A process of making the carbon fiber paper is by the steps of: mixing carbon fibers, wood pulp, and cellulose fibers; using the mixture to obtain a paper pulp; and then forming the carbon fiber paper from the paper pulp. However, the process of making the carbon fiber paper has the following disadvantages: Firstly, the carbon fibers in the carbon fiber paper are not uniformly dispersed, and therefore, the gaps therein are uneven resulting in the carbon fibers having a small specific surface area. Thus, the structure restricts the gas diffusion layer to uniformly diffuse the gases, which is needed for the MEA. Secondly, the carbon fiber paper has high electrical resistance, thereby restricting the transfer of electrons between the gas diffusion layer and the external electrical circuit. As a result, the reaction activity of the MEA is reduced. Thirdly, the carbon fiber paper has poor tensile strength and is difficult to process.

What is needed, therefore, is a membrane electrode assembly having excellent reaction activity and a simple and easily applicable method for making the same.

### BRIEF DESCRIPTION OF THE DRAWINGS

Many aspects of the present membrane electrode assembly and the method for making the same can be better understood with references to the following drawings. The components in the drawings are not necessarily drawn to scale, the emphasis instead being placed upon clearly illustrating the principles of the present membrane electrode assembly and the method for making the same.

FIG. 1 is a schematic view of a membrane electrode assembly in accordance with the present embodiment.

FIG. 2 is a flow chart of a method for making the membrane electrode assembly shown in FIG. 1.

FIG. 3 is a schematic view of a fuel cell in accordance with the present embodiment.

Corresponding reference characters indicate corresponding parts throughout the several views. The exemplifications set out herein illustrate at least one present embodiment of the membrane electrode assembly and the method for making the same, in at least one form, and such exemplifications are not to be construed as limiting the scope of the invention in any manner.

### DETAILED DESCRIPTION OF EXEMPLARY EMBODIMENTS

References will now be made to the drawings, in detail, to describe embodiments of the membrane electrode assembly and the method for making the same.

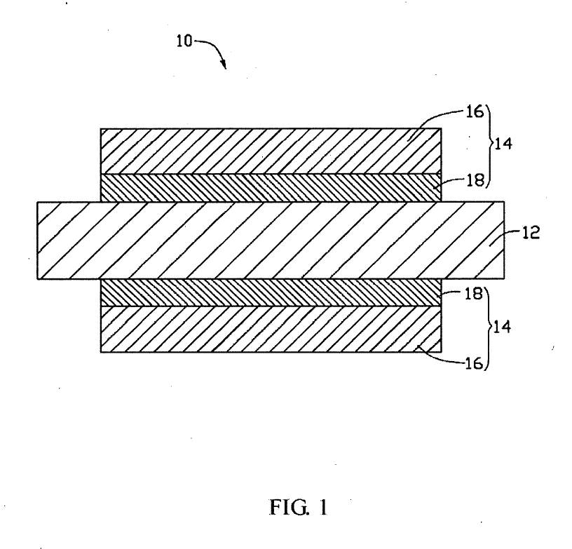

Referring to FIG. 1, a membrane electrode assembly 10 is provided in the present embodiment. The membrane electrode assembly 10 includes a proton exchange membrane 12 and two electrodes 14. The proton exchange membrane 12 has two opposite surfaces. The two electrodes 14 are separately located on the two opposite surfaces of the proton exchange membrane 12. Furthermore, each of the electrodes 14 includes a catalyst layer 18 and a gas diffusion layer 16. The catalyst layer 18 is between the gas diffusion layer 16 and the proton exchange membrane 12.

The gas diffusion layer 16 includes a carbon nanotube film structure. The carbon nanotube film structure includes one or more coplanar carbon nanotube layers or two or more stacked carbon nanotube layers. Adjacent carbon nanotube layers can connect to each other by van der Waals attractive force therebetween. In the present embodiment, each carbon nanotube layer includes one or multiple coplanar carbon nanotube films. Adjacent carbon nanotube films connect to each other by van der Waals attractive force therebetween. The thickness of the carbon nanotube film approximately ranges from 0.5 nanometers to 100 micrometers. The area and thickness of the carbon nanotube film structure is unlimited and could be made according to user-specific needs. Various areas and thickness of carbon nanotube film structures are obtained by placing one film or at least two carbon nanotube films side-by-side and/or stacking a plurality of carbon nanotube films. The area of the carbon nanotube film structure is determined by the number and size of carbon nanotube films in each carbon nanotube layer. Additionally, the thickness of the carbon nanotube film structure is determined by the number and thickness of carbon nanotube layers in the carbon nanotube film structure. Each carbon nanotube film includes a plurality of carbon nanotube segments joined successively end-to-end by van der Waals attractive force therebetween. Each carbon nanotube segments includes a plurality of carbon nanotubes closely arranged and in parallel to each other. The carbon nanotubes in the segments have substantially the same length and are arranged substantially in the same direction. The aligned direction of the carbon nanotubes in any two adjacent carbon nanotube layers form an angle α, where 0≦α≦90°. The carbon nanotube film structure includes a plurality of micropores distributed in the carbon nanotube film structure uniformly. Diameters of the micropores approximately range from 1 to 500 nanometers. The micropores can be used to diffuse the gas. It is to be understood that there can be some variation in the carbon nanotube structures.

The carbon nanotubes in the carbon nanotube film is selected from the group consisting of single-walled carbon nanotubes, double-walled carbon nanotubes, and multi-walled carbon nanotubes. A diameter of each single-walled carbon nanotube approximately ranges from 0.5 to 50 nanometers. A diameter of each double-walled carbon nanotube approximately ranges from 1 to 50 nanometers. A diameter of each multi-walled carbon nanotube approximately ranges from 1.5 to 50 nanometers.

The catalyst materials include metal particles and carbon particles. The metal particles are selected from the group consisting of platinum particles, gold particles, and ruthenium particles. The carbon particles are selected from the group consisting of graphite, carbon black, carbon fiber, and carbon nanotubes. In the present embodiment, the metal particles are platinum; and the carbon particles are carbon nanotubes. The metal particles are dispersed in the carbon particles, thereby forming the catalyst layer 18. The distribution of the metal particles is less than 0.5 mg/cm² (milligram per square centimeter). The material of the proton exchange membrane 12 is selected from the group consisting of perfluorosulfonic acid, polystyrene sulfonic acid, polystyrene trifluoroacetic acid, phenol-formaldehyde resin acid, and hydrocarbons.

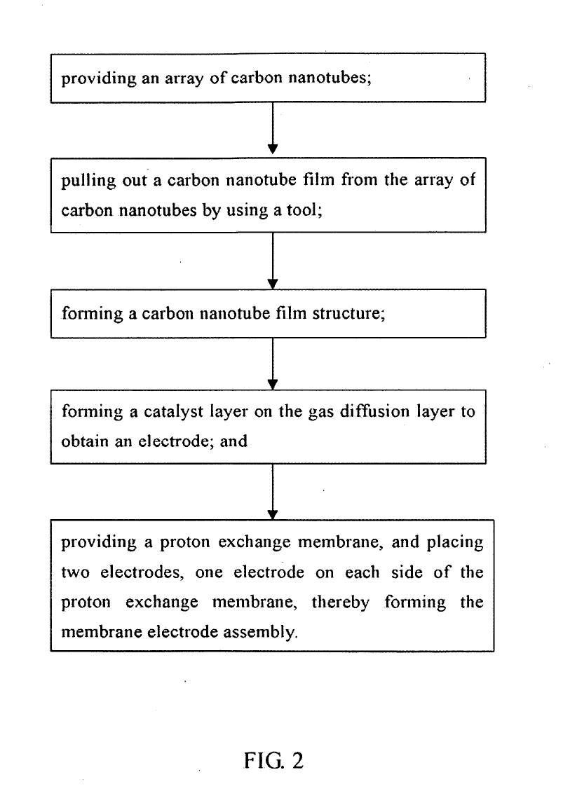

Referring to FIG. 2, a method for making the above-described membrane electrode assembly 10 is provided in the present embodiment. The method includes the steps of: (a) providing an array of carbon nanotubes; (b) pulling out at least one carbon nanotube film from the array of carbon nanotubes by using a tool (e.g., adhesive tape, pliers, tweezers, or another tool allowing multiple carbon nanotubes to be gripped and pulled simultaneously); (c) forming a carbon nanotube film structure; (d) forming a catalyst layer on the gas diffusion layer to obtain an electrode; and (e) providing a proton exchange membrane, and placing two electrodes, one electrode on each side of the proton exchange membrane, thereby forming the membrane electrode assembly.

In step (a), a given super-aligned array of carbon nanotubes can be formed by the substeps of: (a1) providing a substantially flat and smooth substrate; (a2) forming a catalyst layer on the substrate; (a3) annealing the substrate with the catalyst layer in air at a temperature approximately ranging from 700° C. to 900° C. for about 30 to 90 minutes; (a4) heating the substrate with the catalyst layer to a temperature approximately ranging from 500° C. to 740° C. in a furnace with a protective gas therein; and (a5) supplying a carbon source gas to the furnace for about 5 to 30 minutes and growing the super-aligned array of carbon nanotubes on the substrate.

In step (a1), the substrate can be a P-type silicon wafer, an N-type silicon wafer, or a silicon wafer with a film of silicon dioxide thereon. A 4-inch P-type silicon wafer is used as the substrate.

In step (a2), the catalyst can be made of iron (Fe), cobalt (Co), nickel (Ni), or any alloy thereof.

In step (a4), the protective gas can be made up of at least one of nitrogen (N₂), ammonia (NH₃), and a noble gas. In step (a5), the carbon source gas can be a hydrocarbon gas, such as ethylene (C₂H₄), methane (CH₄), acetylene (C₂H₂), ethane (C₂H₆), or any combination thereof.

The super-aligned array of carbon nanotubes can be approximately 200 to 900 micrometers in height, with the super-aligned array including a plurality of carbon nanotubes parallel to each other and approximately perpendicular to the substrate. The carbon nanotubes in the carbon nanotube film can be selected from the group consisting of single-walled carbon nanotubes, double-walled carbon nanotubes, and multi-walled carbon nanotubes. A diameter of each single-walled carbon nanotube approximately ranges from 0.5 to 50 nanometers. A diameter of each double-walled carbon nanotube approximately ranges from 1 to 50 nanometers. A diameter of each multi-walled carbon nanotube approximately ranges from 1.5 to 50 nanometers.

The super-aligned array of carbon nanotubes formed under the above conditions is essentially free of impurities, such as carbonaceous or residual catalyst particles. The carbon nanotubes in the super-aligned array are closely packed together by van der Waals attractive force.

In step (b), the carbon nanotube film can be formed by the substeps of: (b1) selecting a plurality of carbon nanotubes having a predetermined width from the super-aligned array of carbon nanotubes; and (b2) pulling the carbon nanotube segments, made of nanotube, at an even/uniform speed to achieve a uniform carbon nanotube film.

In step (b1), the carbon nanotube segments having a predetermined width can be selected by using a tool, such as the adhesive tape, to contact the super-aligned array. In step (b2), the pulling direction is substantially perpendicular to the growing direction of the super-aligned array of carbon nanotubes.

More specifically, during the pulling process, as the initial carbon nanotube segments are drawn out, other carbon nanotube segments are also drawn out end-to-end due to van der Waals attractive force between ends of adjacent segments. This process of drawing helps provide a continuous and uniform carbon nanotube film having a predetermined width can be formed. The carbon nanotube film includes a plurality of carbon nanotube segments containing a plurality of carbon nanotubes. The carbon nanotubes in the carbon nanotube film are all substantially parallel to the pulling/drawing direction of the carbon nanotube film, and the carbon nanotube film produced in such manner can be selectively formed to have a predetermined width. The carbon nanotube film formed by the pulling/drawing method has a superior uniformity of thickness and conductivity over a typically disordered carbon nanotube film. Furthermore, the pulling/drawing method is simple, fast, and suitable for industrial applications.

The width of the carbon nanotube film depends on a size of the carbon nanotube array. The length of the carbon nanotube film can be arbitrarily set as desired. In one useful embodiment, when the substrate is a 4-inch P-type silicon wafer, the width of the carbon nanotube film approximately ranges from 0.01 to 10 centimeters, while the thickness of the carbon nanotube film approximately ranges from 0.5 nanometers to 100 micrometers. The carbon nanotubes in the carbon nanotube film can be selected from the group consisting of single-walled carbon nanotubes, double-walled carbon nanotubes, and multi-walled carbon nanotubes. Diameters of the single-walled carbon nanotubes approximately range from 0.5 to 50 nanometers. Diameters of the double-walled carbon nanotubes approximately range from 1 to 50 nanometers. Diameters of the multi-walled carbon nanotubes approximately range from 1.5 to 50 nanometers.

In step (c), the step of forming a carbon nanotube film structure includes the substeps of: (c1) providing a substrate having a surface; (c2) attaching at least one carbon nanotube film onto the surface of the substrate; (c3) removing the unwanted carbon nanotube film; and (c4) removing the substrate to obtain the carbon nanotube film structure. In the present embodiment, the carbon nanotube film structure is obtained by placing at least two carbon nanotube films side-by-side and/or overlapping adjacent carbon nanotube films. At least two carbon nanotube films are located side-by-side form a carbon nanotube layer. It is to be understood in other embodiments that the carbon nanotube layer can comprise of multiple films with at least one nanotube film stacked upon another nanotube film. The carbon nanotube film structure, of the present embodiment, includes at least two stacking carbon nanotube layers. The alignment of the carbon nanotubes in any two adjacent carbon nanotube layers form an angle α, and 0≦α≦90°. The angle αis 90° in the present embodiment. After step (c4), a process of cutting the carbon nanotube film structure is provided to form a predetermined size and various shapes of the gas diffusion layer.

The area of the substrate can be chosen according to the user-specific needs. The substrate can also be replaced with a frame. Because the carbon nanotubes in the super-aligned carbon nanotube array have a high purity and a high specific surface area, the carbon nanotube film is adherent in nature. As such, the carbon nanotube film can be directly adhered to the substrate or frame. The unwanted carbon nanotube film can be removed.

A step of treating the carbon nanotube film structure with an organic solvent is optional after step (c). The organic solvent is volatilizable and can be selected from the group consisting of ethanol, methanol, acetone, dichloroethane, chloroform, and any appropriate mixture thereof. In the present embodiment, the organic solvent is ethanol. Specifically, the carbon nanotube film structure can be treated through dripping organic solvent onto the surface of the carbon nanotube film structure or soaking the entire carbon nanotube film structure in an organic solvent. After being soaked by the organic solvent, microscopically, carbon nanotube strings will be formed by some adjacent carbon nanotubes bundling together, due to the surface tension of the organic solvent. In one aspect, due to the decrease of the specific surface area via bundling, the mechanical strength and toughness of the carbon nanotube film are increased and the coefficient of friction of the carbon nanotube films is reduced. Macroscopically, the film will be an approximately uniform carbon nanotube film.

In step (d), the catalyst layer 18 is formed by the substeps of: (d1) putting metal particles and carbon particles into a dispersion solution; (d2) adding water and a active surface agent to the dispersion solution to obtain a catalyst slurry; (d3) coating the catalyst slurry on the gas diffusion layer and drying the catalyst slurry, thereby forming the catalyst layer on the carbon nanotube film structure to obtain the electrode.

In step (d1), the metal particles are selected from the group consisting of platinum particles, gold particles and ruthenium particles. The carbon particles are selected from the group consisting of graphite, carbon black, carbon fibers, and carbon nanotubes. The metal particles load on surfaces of the carbon particles. Furthermore, distribution of the metal particles is less than 0.5 mg/cm². The carbon particles have the properties of high conductivity, a high specific surface area, and good corrosion resistance. In order to enhance the dispersion of carbon particles in the dispersion solution, a ball mill refiner is used to mill the carbon particles. CHF 1000 resin is dissolved in dimethyl acetamide to form the dispersion solution. A mass percentage of the CHF 1000 resin in the dispersion solution is about 5%.

In step (d2), the active surface agent is used to restrain agglomeration of the carbon particles. Thus, in the present embodiment, isopropanol is used as the active surface agent. After the water and the active surface agent have been added into the dispersion solution, a process of mixing the dispersion solution is executed by ultrasonic dispersing or agitating.

In step (d3), a process of coating is executed by a spraying method, an immersing method, or a screen printing method. The above-described methods can ensure that the catalyst slurry is uniformly and densely coated on the carbon nanotube film. In order to reduce the cracks and voids in the catalyst layer 18, the drying method is executed at a low temperature. The drying process is selected from the group consisting of an oven drying method and a sintering method.

In step (e), the two electrodes 14 are attached on the two opposite surfaces of the proton exchange membrane 12 by a heat pressing process. Furthermore, the catalyst layer 18 is configured for being sandwiched between the gas diffusion layer 16 and the proton exchange membrane 12. The material of the proton exchange membrane 12 is selected from the group consisting of perfluorosulfonic acid, polystyrene sulfonic acid, polystyrene trifluoroacetic acid, phenol formaldehyde resin acid, and hydrocarbons.

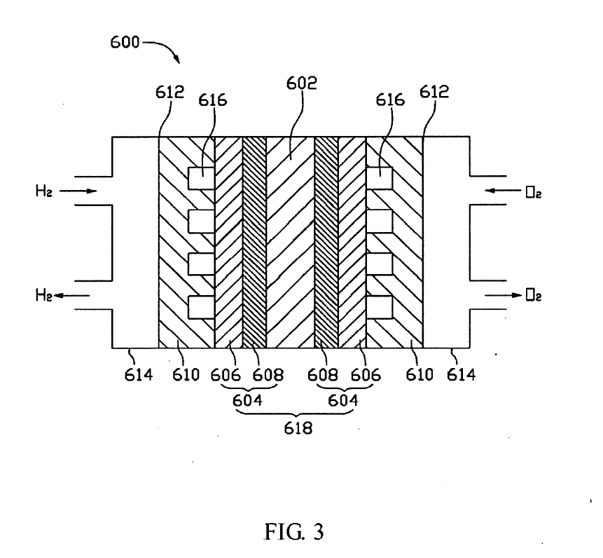

Referring to FIG. 3, a fuel cell 600 is further provided in the present embodiment. The fuel cell 600 includes a membrane electrode assembly (MEA) 618, two flow field plates (FFP) 610, two current collector plates (CCP) 612, as well as related support equipment 614. The MEA 618 includes a proton exchange membrane 602 and two electrodes 604 separately located on two opposite surfaces of the proton exchange membrane 602. Furthermore, each electrode includes a catalyst layer 608 and a gas diffusion layer 606. The catalyst layer 608 is located between the gas diffusion layer 606 and the proton exchange membrane 602. The proton exchange membrane 602 is selected from the group comprising of perfluorosulfonic acid, polystyrene sulfonic acid, polystyrene trifluoroacetic acid, phenol-formaldehyde resin acid, and hydrocarbons. The proton exchange membrane 602 is used to conduct the protons generated in the MEA 618, and separate the fuel gases and the oxidant gases. The catalyst layer 608 includes catalyst materials and carriers. The catalyst materials are selected from the group consisting of metal particles, such as platinum particles, gold particles or ruthenium particles. The carrier is generally carbon particles, such as graphite, carbon black, carbon fiber or carbon nanotubes. The gas diffusion layer 606 is the carbon nanotube film produced in the present embodiment. The FFP 610 is made of metals or conductive carbon materials. Each FFP 610 is located on a surface of each electrode 604 facing away from the proton exchange membrane 602. The FFP 610 has at least one flow field groove 616. The flow field groove 616 is contacted with the gas diffusion layer 606. Thus, the flow field groove 616 is used to transport the fuel gases, the oxidant gases, and the reaction product (i.e. water). The CCP 612 is made of conductive materials. Each CCP 612 is located on a surface of each FFP 610 facing away from the proton exchange membrane 602. Thus, the CCP 612 is used to collect and conduct the electrons in the work process of MEA 618. The related support equipments 614 include blowers, valves, and pipelines. The blower is connected with the flow field plate 610 via pipelines. The blowers blow the fuel gases and the oxidant gases. The electrode 604 near the oxidant gases is defined as cathode and the electrode 604 near the fuel gases is defined as anode.

In the working process of the fuel cell 600, fuel gases (i.e. hydrogen) and oxidant gases (i.e. pure oxygen or air containing oxygen) are applied to a surface of each electrode through the flow field plates 610 by the related equipments 614. Specifically, hydrogen is applied to an anode and oxygen is applied to a cathode. In one side of the MEA 618, after the hydrogen has been applied to the catalyst layer 608, a reaction of each hydrogen molecule is as follows: H₂→2H⁺+2e. The hydrogen ions generated by the above-described reaction reach the cathode through the proton exchange membrane 602. At the same time, the electrons generated by the reaction also arrive at the cathode by an external electrical circuit. In the other side of the MEA 618, oxygen is also applied to the cathode. Thus, the oxygen reacts with the hydrogen ions and electrons as shown in the following equation: 1/20₂+2H⁺+2e→H₂O. In the electrochemical reaction process, the electrons form an electrical current, and as a result, are able to output electrical energy. Accordingly, the water generated by the reaction penetrates the gas diffusion layer 606 and the flow field plate 610, thereby removing itself from the MEA 608. From the above-described process, it is known that the gas diffusion layer 606 reacts as a channel for the fuel gases, oxidant gases, as well as the electrons. Fuel gas and oxidant gases from the gas diffusion layer 606 arrive at the catalyst layer; and the electrons through the gas diffusion layer 606 are connected to the external electrical circuit.

In the present embodiment, the gas diffusion layer 606 includes the carbon nanotube film structure. The carbon nanotube film structure includes a plurality of carbon nanotube segments. The carbon nanotube segments are joined successively end-to-end by van der Waals attractive force therebetween, wherein each carbon nanotube segment includes a plurality of carbon nanotubes being closely arranged and in parallel to each other. There may be some overlap between adjacent segments. Thus, the carbon nanotube film structure includes a plurality of micropores distributed in the carbon nanotube film structure uniformly and a large specific surface area. Even after being treated, the nanotube film structure still has a relatively large specific surface area. As such, on one side of MEA 618, the hydrogen can be effectively and uniformly diffused in the carbon nanotube film. The hydrogen fully contacts with metal particles in the catalyst layer 608. Thus, the catalytic reaction activity of the metal particles with the hydrogen is enhanced. In another side of the MEA 618, the oxidant gases are also uniformly diffused to the catalyst layer 608 through the carbon nanotube film, thereby fully contacting with the metal particles of the catalyst layer 608. Thus, the catalytic reaction activity of the metal particles with the hydrogen ions and electrons is enhanced. Due to the carbon nanotube film having good conductivity, the electrons needed or generated in the reactions are quickly conducted by the carbon nanotube film.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

It is also to be understood that the above description and the claims drawn to a method may include some indication in reference to certain steps. However, the indication used is only to be viewed for identification purposes and not as a suggestion as to an order for the steps.

What is claimed is:

1. A membrane electrode assembly comprising:
a proton exchange membrane; and
a first electrode and a second electrode located on opposite sides of the proton exchange membrane; each electrode comprising a catalyst layer and a gas diffusion layer;
the catalyst layer is located between the gas diffusion layer and the proton exchange membrane; and the gas diffusion layer comprising a carbon nanotube film structure,
the carbon nanotube film structure comprising at least one carbon nanotube layer, the carbon nanotube layer comprising a plurality of carbon nanotubes oriented along a same direction.

2. The membrane electrode assembly as claimed in claim 1, wherein the carbon nanotube film structure comprises at least two stacked carbon nanotube layers, and adjacent carbon nanotube layers are joined to each other by van der Waals attractive force therebetween.

3. The membrane electrode assembly as claimed in claim 2, wherein an aligned direction of the carbon nanotubes in any two adjacent carbon nanotube layers forms an angle a, and the angle a ranges from 0° to 90°.

4. The membrane electrode assembly as claimed in claim 1, wherein each carbon nanotube layer comprises one or more carbon nanotube films wherein adjacent carbon nanotube films are joined to each other by van der Waals attractive force therebetween.

5. The membrane electrode assembly as claimed in claim 4, wherein a thickness of the carbon nanotube film approximately ranges from 0.5 nanometers to 100 micrometers.

6. The membrane electrode assembly as claimed in claim 4, wherein each carbon nanotube film comprises a plurality of carbon nanotube segments joined successively end-to-end by van der Waals attractive force therebetween.

7. The membrane electrode assembly as claimed in claim 6, wherein each carbon nanotube segment comprises a plurality of carbon nanotubes closely arranged and in parallel to each other.

8. The membrane electrode assembly as claimed in claim 7, wherein the carbon nanotubes in the carbon nanotube film is selected from the group consisting of single-walled carbon nanotubes, double-walled carbon nanotubes, and multi-walled carbon nanotubes.

9. The membrane electrode assembly as claimed in claim 7, wherein a diameter of the carbon nanotubes approximately ranges from 0.5 to 50 nanometers, and a length of the carbon nanotubes approximately ranges from 200 micrometers to 900 micrometers.

10. The membrane electrode assembly as claimed in claim 1, wherein the carbon nanotube film structure comprises a plurality of micropores distributed therein, and diameters of the micropores approximately range from 1 nanometer to 500 nanometers.

11. The membrane electrode assembly as claimed in claim 1, wherein the material of the proton exchange membrane is selected from the group consisting of perfluorosulfonic acid, polystyrene sulfonic acid, polystyrene trifluoroacetic acid, phenol formaldehyde resin acid, and hydrocarbons.

12. The membrane electrode assembly as claimed in claim 1, wherein the catalyst layer is composed of metal particles and carbon particles, and the metal particles are selected from the group consisting of platinum particles, gold particles, and ruthenium particles; and the carbon particles are selected from the group consisting of graphite, carbon black, carbon fiber, and carbon nanotubes.

13. A method for making a membrane electrode assembly, the method comprising the steps of:
(a) providing an array of carbon nanotubes, and a proton exchange membrane;
(b) pulling out at least one carbon nanotube film from the array of carbon nanotubes;
(c) forming a carbon nanotube film structure with the carbon nanotube film as a gas diffusion layer and a catalyst layer on the gas diffusion layer to obtain an electrode; and
(e) placing two electrodes, one electrode on each side of the proton exchange membrane.

14. The method as claimed in claim 13, wherein the array of carbon nanotubes is a supper-aligned array of carbon nanotubes.

15. The method as claimed in claim 13, wherein step (b) comprises the following substeps: (b1) selecting one or more carbon nanotube segments having a predetermined width from the super-aligned array of carbon nanotubes; and (b2) pulling the one or more carbon nanotube segments at a uniform speed to achieve a uniform carbon nanotube film.

16. The method as claimed in claim 13, wherein step (c) comprises following substeps: (c1) providing a substrate or a frame; (c2) attaching at least one carbon nanotube film onto the substrate or the frame; (c3) removing the unwanted portion of the carbon nanotube film and treating the carbon nanotube film with an organic solvent; and (c4) separating the carbon nanotube film from the substrate or the frame to obtain the carbon nanotube film structure.

17. The method as claimed in claim 16, wherein in step (c2), the attaching at least one carbon nanotube film is executed by placing at least two carbon nanotube films side-by-side; stacking at least two carbon nanotube films; or placing at least two carbon nanotube films side-by-side and stacking at least two carbon nanotube films onto the substrate or the frame.

18. The method as claimed in claim 16, wherein the organic solvent is selected from the group consisting of ethanol, methanol, acetone, dichloroethane, chloroform, and any appropriate mixture thereof, and the carbon nanotube film structure is treated by applying organic solvents onto the carbon nanotube film structure or dipping the entire carbon nanotube film structure in organic solvents.

19. The method as claimed in claim 13, wherein step (d) comprises the substeps of: (d1) putting metal particles and carbon particles into a dispersion solution; (d2) adding water and an active surface agent to the dispersion solution to obtain a catalyst slurry; and (d3) coating the catalyst slurry on the carbon nanotube film structure and drying the catalyst slurry, thereby forming the catalyst layer on the carbon nanotube film structure to obtain the electrode.

20. The method as claimed in claim 13, wherein in step (e), the two electrodes are attached on the two opposite surfaces of the proton exchange membrane by heat pressing.
